(19) United States
(12) Patent Application Publication
(10) Pub. No.: US 2007/0135944 A1
(43) Pub. Date: Jun. 14, 2007

(54) Method, apparatus and computer program product for providing status of a process

(76) Inventors: James J. Schmid, Kirkland, WA (US); Patrick L. Pfrehm, McMinnville, OR (US); Brad Kelly, Minden, NV (US); Chad Knodle, Dayton, NV (US); Danni David, Mumbai (IN)

Correspondence Address: CANTOR COLBURN, LLP, 55 GRIFFIN ROAD SOUTH, BLOOMFIELD, CT, 06002, US

(21) Appl. No.: 11/301,399

(22) Filed: Dec. 12, 2005

(51) Int. Cl. G05B 15/00

(52) U.S. Cl. 700/83

(57) ABSTRACT

An apparatus and method for receiving operational data and displaying summaries of processes for an industrial system includes a block object to define blocks for defining aspects of variables related to the operational data as well as a display client for using the blocks to provide useful and concise summaries of the processes.

### BACKGROUND OF THE INVENTION

This invention relates generally to a system for grouping and managing multiple process related variables for an industrial system.

Consider, for example, control room operators operating a power generation facility. When the power plant operators view processes associated with a system using a display type console, a large number of individual parameters are observed. These parameters are dynamic (or variable) and dependent upon aspects of the facility operations. Collectively, a certain set of variables is indicative of the status of the process. In operations parlance, each member of the set of variables is commonly referred to as a “tag.”

For obvious reasons, evaluation of process status by viewing a set of tags can be confusing. This confusion can be exacerbated by the fact that a tag for one process can also relate to another process.

A technique for grouping all the associated variables together to display a relevant process summary is desired to better allow operators to monitor a process. Since aspects of a process may vary from one to another, a generic solution is needed. For example, the solution should provide facilities for selecting, grouping and managing variables as well as displaying derived data in a relevant visual format, such as a bar graph, trend plot, or other.

### BRIEF DESCRIPTION OF THE INVENTION

The above discussed and other drawbacks and deficiencies are overcome or alleviated by the teachings disclosed herein.

An apparatus is disclosed for providing a summary for at least one process of a system, includes a block object for accepting input data descriptive of the at least one process and for grouping as a block at least one variable of the input data with at least one attribute for the variable; and a display client for reading the block and producing output to display the summary for the at least one process.

Also disclosed is a method where the technical effect is to provide a status for at least one process of a system, wherein the method includes selecting a block having at least one variable descriptive of the process with at least one attribute for the variable; using a display client, reading the block to produce output; and, displaying the output as the summary for the at least one process.

Further disclosed is an apparatus for providing a summary for at least one process of a system, includes means for accepting input data descriptive of the at least one process and for grouping as a block at least one variable of the input data with at least one attribute for the variable; and display means for reading the block and producing output to display the summary for the at least one process.

The above-discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several Figures:

FIG. 1 provides an overview of the software component as installed;

FIG. 2 depicts a process for assembling a block;

FIG. 3 depicts a user interface for selecting variables;

FIG. 4 depicts the user interface and a pull down menu;

FIG. 5 depicts an introductory screen for setting up a customizable information panel (CIP);

FIG. 6 depicts a user interface for defining a CIP;

FIG. 7 depicts the user interface of FIG. 6 and a pick list for populating a data field;

FIG. 8 depicts the user interface of FIG. 6 and a user-fillable field for populating a data field;

FIG. 9 depicts the user interface of FIG. 6 and check boxes for populating a data field;

FIG. 10 depicts an exemplary bar graph display;

FIG. 11 depicts an exemplary graphic display;

FIG. 12 depicts one embodiment of sidebar arrow indicators;

FIG. 13 depicts an exemplary context menu for creating the bar graph; and,

FIG. 14 depicts one embodiment of a pop-up menu for controlling aspects of the bar graph.

### DETAILED DESCRIPTION THE INVENTION

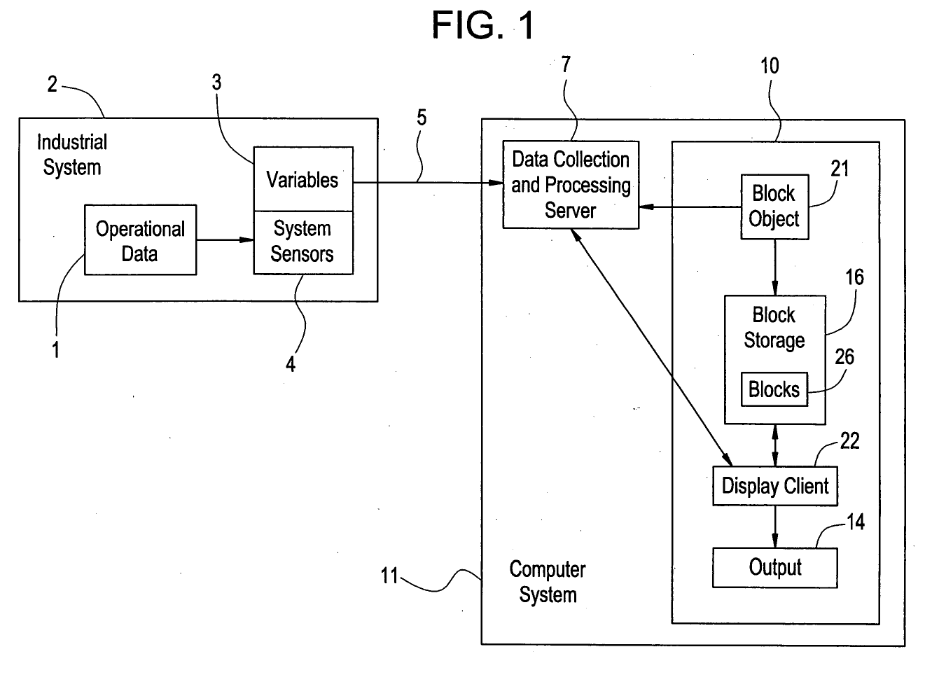

Referring to FIG. 1, there are shown aspects of a software component 10 for reading and displaying operational data 1 from an industrial system 2. One non-limiting example of an industrial system 2 is an electric generation facility, commonly referred as a “power plant.”

In this illustration, operational data 1 from the industrial system 2 is collected (typically on a real-time basis) using system sensors 4 and other known techniques (such as referencing tables of static values). Each stream of operational data 1 is assigned to (or described by) a variable 3. Thus, variables 3 are indicative of processes ongoing within the industrial system 2, either singularly or when grouped into a set.

The term “process”, as used herein is non-limiting and indicative of data sources only. For example, a process may be considered dynamic or static. That is, in one embodiment, a continuous stream of operational data 1 is collected. In another embodiment, monitoring is infrequent and generally amounts to periodic checking of status.

The frequency of data processing is determined according to a variety of constraints, such as the applicable process, rate of change in the process, etc, . . . . Accordingly, and as used herein, while the software component 10 provides for and supports high rates of input, the software component 10 is not limited in this manner. For example, the software component 10 often is configured to provide updates that on are at least one of a continuous basis, a real-time basis, about or approximately a real-time basis, a periodic basis and a frequent basis. That is, and it should be noted, the software component 10 is not dependant upon the rate of data input. Therefore, terms used herein such as “real-time basis” are merely illustrative and not exacting when considering the basis for updates. As an example, it is recognized that while some definitions of real-time may call for instantaneous data transmission, exemplary factors such as transmission and processing delays are not limiting of the teachings herein. Therefore “about real time” and “approximately real time” data input is adequate to practice some embodiments of the software component 10.

In typical embodiments, the stream of data associated with each variable 3 is used as input data 5. This input data 5 is typically collected and maintained by a computer system 11 through use of a system such as by a data collection and processing server 7 depicted.

Non-limiting examples of input data 5 include at least one of historic data, predictive data, optimal data, calculated data, derived data, reference data, real-time data, data collected by the system sensors 4, manual input data and projected data. In short, the software component 10 accepts as input data 5 virtually any form of data. As techniques for monitoring of industrial systems 2 are well known, further discussion is not warranted and is therefore generally omitted herein.

The software component 10 generally includes two main sub-components. The first, referred to as a “block object 21” accesses input data 5 and assigns user designated criteria for governing display of the input data 5. The block object 21 is used to create at least one block 26 and stores each block 26 in block storage 16. The second main sub-component is referred to as a “display client 22.” In one embodiment, the display client 22 receives input data 5 and displays the input data 5 as output 14 according to the instructions contained in the related block 26. By making use of the blocks 26 created using the block object 21 and the display client 22, the software component 10 provides resources and techniques for generating meaningful data summaries.

It should be noted that aspects of communications discussed herein are non-limiting and merely illustrative. For example, although the foregoing discusses communication in terms of the display client 22 receiving input data 5, it should be recognized that the display client 22 may interrogate the data collection and processing server 7 for input data 5. Accordingly, the teachings herein (including directional arrows, such as those depicted in FIG. 1) are merely illustrate the various paths of information and communication flow and are not limiting as such.

As discussed herein, when the at least one variable 3 is selected and used to generate an indication related to a process of the industrial system 2, the at least one variable 3 may be referred to as at least one “tag.” Therefore, tags, as used herein, are variables 3 and properties thereof derived from and used to describe operational data 1 of an industrial system 2.

As alluded to herein from time to time, the software component 10 may, for example, generate or call for “optimal” data, or make use of an “optimizer.” In these embodiments, the associated terms (e.g., optimal, optimized, etc, . . .) make reference to techniques for developing goals for parameters. It should be recognized that the techniques typically employ a variety of inputs, one example being a set of rules and predictors. Accordingly, one skilled in the art will recognize that “optimal” data can usually be improved upon. For example, the underlying calculation for an “optimal” number may account for only the major influences upon a variable. Subsequently finding ways to detect and incorporate the influence of other aspects of the industrial system 2 may provide for improved estimations of the optimal value. Therefore, the term “optimal” and other related terms used herein, can also be taken to mean “improved.” Accordingly, it should be recognized that an optimal value or optimized variable does not necessarily represent perfection, and that subsequent improvements may likely be had. It should also be recognized that values be regarded as “improved” or “optimal” represent estimated values.

In typical embodiments, the software component 10 is implemented on a computer system 11 that is assembled from commonly available computer components, environments and technologies. In some embodiments, the software component 10 is an “add in.” That is, the software component 10 is added to the existing computer system 11 for the industrial system 2 as an enhancement thereto.

It should be noted that the software component 10 disclosed herein may take advantage of a variety of known computer technologies. As such, although the software component 10 is typically implemented on a server of the computer system 11 for the industrial system 2 using a local area network, this is not required. For example, in other embodiments, the software component 10 may be networked and portions implemented remotely, such as through the Internet. This latter embodiment may be particularly advantageous for remote or central operations of multiple industrial systems 2.

Further, the software component 10 is typically developed using programming languages supportive of implementation in personal computer environments.

It should be noted that non-limiting examples of display systems include computer monitors, projection systems and printers. It should be recognized that other techniques for output may be useful as well, such as where output is routed to data storage for subsequent review of operational events. One example of where such a technique may be useful includes training exercises for operators of the industrial system 2. However, for the non-limiting embodiments presented herein, the software component 10 is used for about real-time monitoring of any designated process variable 3. Accordingly, the term “display systems” generally refers to visual display systems supportive of about real-time dynamic data.

As further aspects of computer technologies are well known to those skilled in the art, these technologies are generally not discussed further herein.

It should further be recognized that although this disclosure presents the invention in terms of managing aspects of industrial systems 2, the teachings herein can be applied to other systems having sets of complex, dynamic and related data. As one example, it should be recognized that aspects of the teachings herein can be useful for managing aspects of patient care in a medical setting. Therefore, reference to industrial systems 2 is merely illustrative and non-limiting of the teachings herein.

It should be recognized that various aspects of the software component 10 as disclosed herein may be rearranged, merged or omitted as considered appropriate. Accordingly, many aspects (such as architecture and functionality) of the embodiments disclosed herein are illustrative only and non-limiting of these teachings.

The advantages of the techniques discussed in the foregoing overview are better understood when considering the block object 21 and the display client 22 in more detail. Accordingly, aspects of the block object 21 and the display client 22 are presented and discussed in the separate sections identified below.

I. The Block Object 21

The block object 21 is a software component that provides a generic method for creating each block 26. Typically, each block 26 includes a selected set (i.e., a group) of at least one variable 3, as well as other relevant attributes. Once selected, each variable 3 is a member (i.e., tag) of the block 26. Each variable 3 is selected and then added to the block 26 by various techniques, such as, in non-limiting examples, manually by a user or as part of an original configuration of blocks 26 during initial configuration of the software component 10. Generally, blocks 26 are stored in block storage 16. Block storage 16 may include, in non-limiting examples, individual data files, a database and XML structures.

In non-limiting examples, the user may access the block object 21 when the user wants to create a new block 26; when the user wishes to add variables 3 to a block 26; when the user wishes to change the manner in which output 14 is viewed; when the user wishes to customize data, such as to rearrange output 14 into an operator friendly format; when the user wishes to make some properties of the output 14 changeable via the display client 22; and, when the user wishes to hide or show aspects of the output 14.

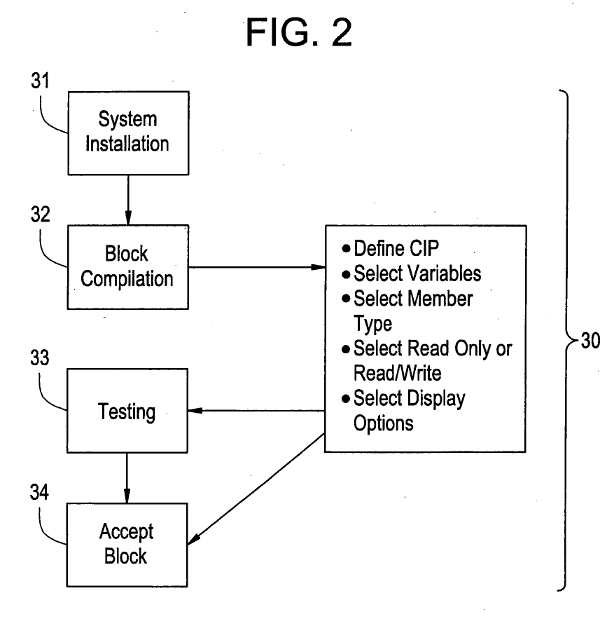

Referring to FIG. 2, there is shown an exemplary process for block assembly 30 (i.e., creating a block 26) using the block object 21. In the embodiment illustrated, block assembly 30 begins with system installation 31. During system installation 31, variables 3 and properties are defined and loaded into the software component 10. In some embodiments, blocks 26 are predefined and are loaded during or with the software component 10 installation. Typical installation stages include identifying and populating the software component 10 with the list of variables 3 and making any needed associations to provide for collection of operational data 1.

A next stage in block assembly 30 calls for block compilation 32. Non-limiting aspects of block compilation 32 include defining a customizable information panel (CIP), selecting variables 3 (i.e., defining tags), selecting properties of the variables 3, establishing types and rules and setting display options. Aspects of each block 26 may be configured using non-limiting criteria such as attribute type, aspects of visibility, description and manual controls. It should be understood that block compilation 32 may involve selecting and adjusting a variety of operational aspects of each block 26 as well as display aspects of each block 26.

Another stage in block assembly 30 optionally calls for block testing 33. Various techniques may be used to complete block testing 33, many of which are known to those skilled in the art. In a non-limiting example, a testing database may be used to fabricate dummy data for use with the block 26 being tested.

Once each block 26 has been configured and any desired testing is completed, the user may then accept the block 26 for use in production.

Editing of the block 26 may occur in a manner similar to block assembly 30, with exceptions being that it may not be necessary to complete each of the stages for block assembly 30 or to complete the stages in a particular order. In some instances, only a subset of block assembly 30 stages may be called for to edit each block 26.

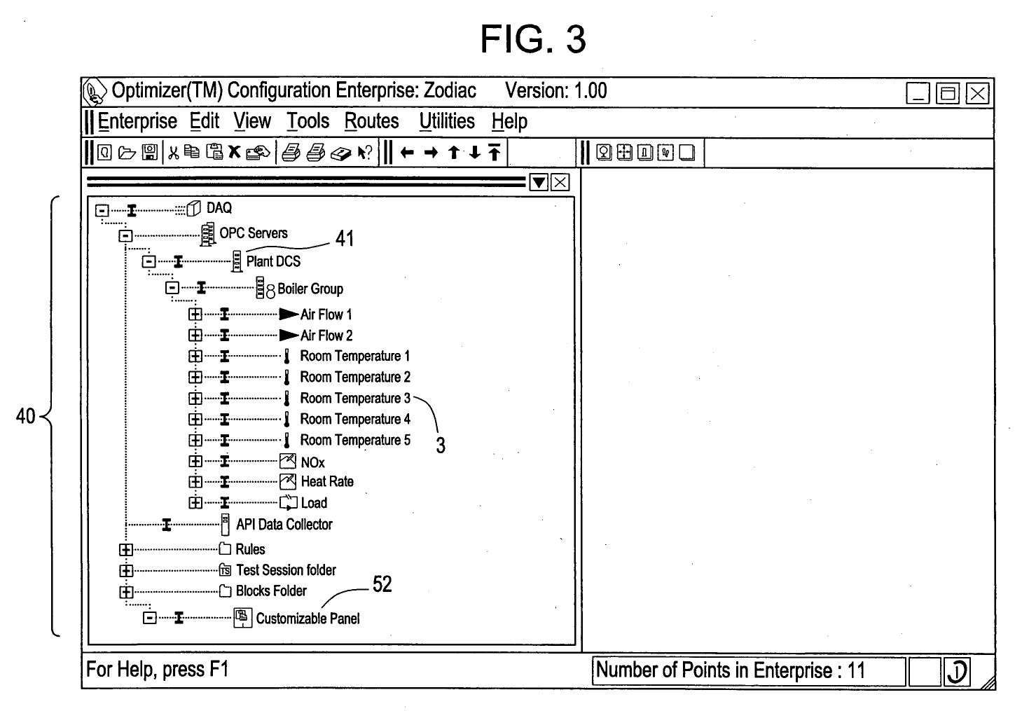

In some embodiments, the foregoing stages for block assembly 30 are completed using graphical user interface (GUI) technology where the user manually interfaces with the software component 10 to produce each block 26. Exemplary embodiments of GUI technology for block assembly 30 are provided in FIGS. 3-9.

In typical embodiments, the block object 21 provides an organized interface (such as a control tree of variables 3) that represents an overview of the industrial system 2. FIG. 3 depicts an exemplary embodiment of a control tree 40.

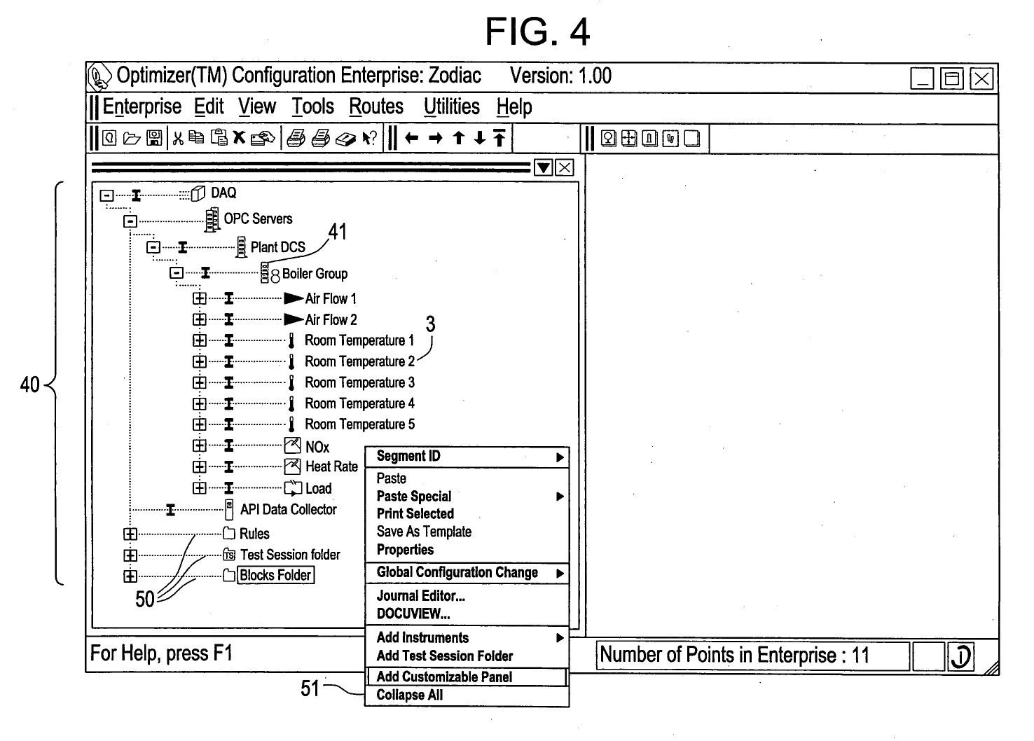

Referring to FIG. 3, an exemplary display of a technique for presenting a hierarchy of items is presented. The exemplary control tree 40 shows various groupings of variables 3. In FIG. 3, a portion of the structure of the control tree 40 has been opened or unfolded so as to show certain variables 3 within a control group 41. Also shown in FIG. 3 is a customizable information panel (CIP) 52, as discussed with reference to FIG. 4.

Referring to FIG. 4, there are shown management resources 50 of the block object 21, aspects of which are shown in the control tree 40. A menu 51 calls processes for block assembly 30 which make use of the management resources 50. An exemplary process is the process of generating customizable information panels 52, which makes use of management resources 50, such as storage.

In some embodiments, the user will add the block 26 by convenient input techniques, such as for example, right clicking on a folder within the control tree 40 or the optimization data acquisition (root directory or parent in the control tree 40). The right clicking command typically calls the menu 51 wherein the user selects a command, for example, to “Add Customizable Panel.” Referring back to FIG. 3, this results in the addition of the customizable information panel (CIP) 52.

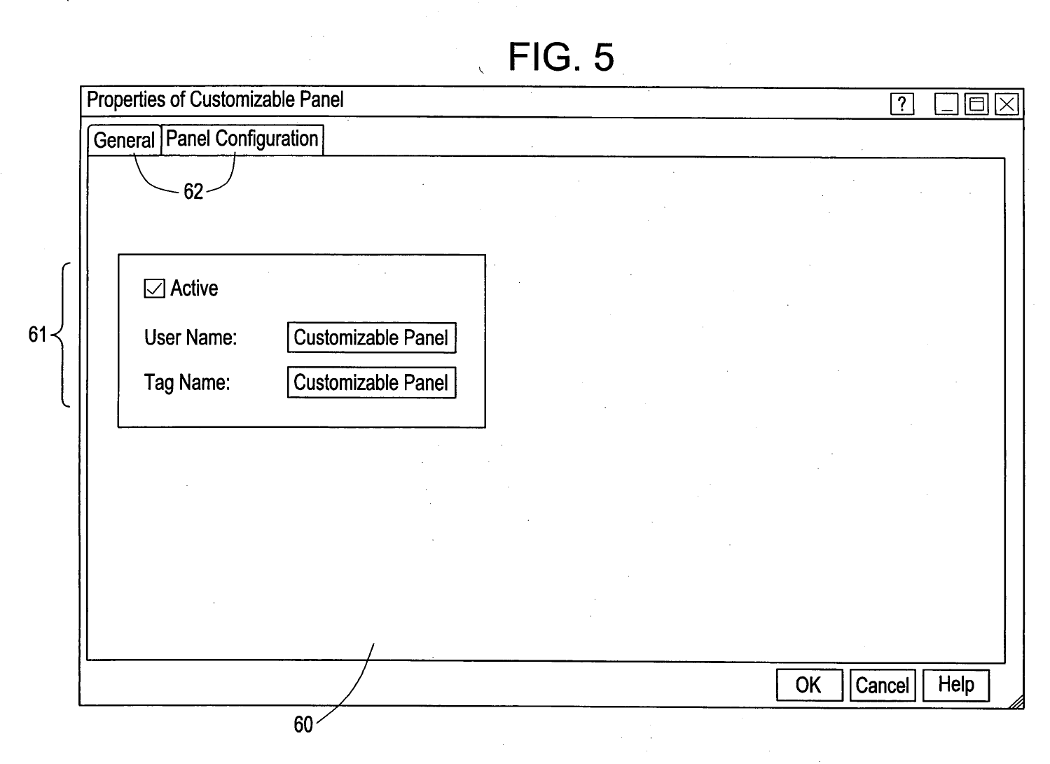

Customizable information panels (CIP) 52 are provided in the block object 21 to provide for the creation of user defined blocks 26. The CIP 52 typically provide facilities for defining many aspects of a block 26. Exemplary embodiments of GUI displays for management of customizable information panels are depicted in FIGS. 5-9.

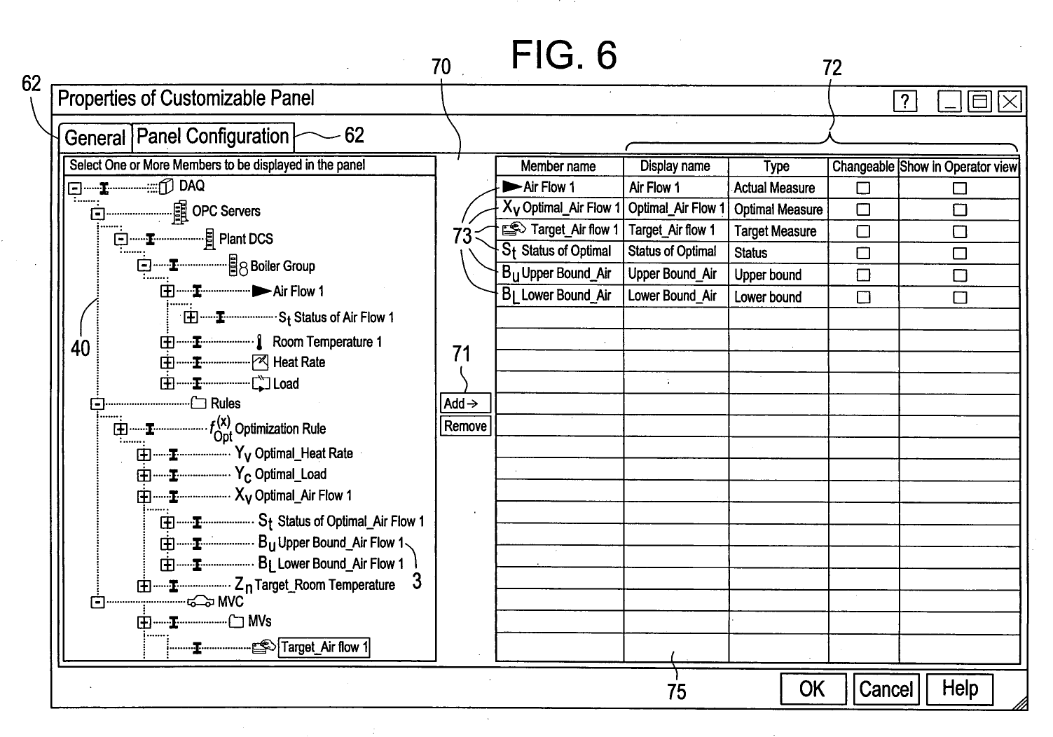

Referring to FIG. 5, there is shown a CIP introduction 60 for the customizable information panel (CIP) 52. In some embodiments, on adding the CIP 52, the CIP introduction 60 appears and displays CIP properties 61. Exemplary (and user customizable) CIP properties 61 include, without limitation, the user name, tag name and activity status. In some embodiments, the CIP introduction 60 includes CIP tabs 62 which provide for navigation between sections of the CIP 52. In some embodiments, the user selects a Panel Configuration CIP tab 62 to access a panel configuration page 70, as depicted in FIG. 6.

Referring to FIG. 6, in this exemplary embodiment, the panel configuration page 70 provides a view of the control tree 40 used for the selection of variables 3. Typically, selection (or de-selection) is completed by use of a selection facility 71. Attributes 72 for each tag 73 (selected variable 3) may be adjusted by users as desired.

Exemplary tags 73 include, without limitation, the status of a respective variable 3; the variables 3 related to certain points or results (either manually identified or as derived by custom rules or artificial intelligence rules); an upper and lower bound for a measurement, constraints or objectives for optimization; and, a configured soft bounds for each measurement, constraint or objective a the decision model of a variable optimization routine.

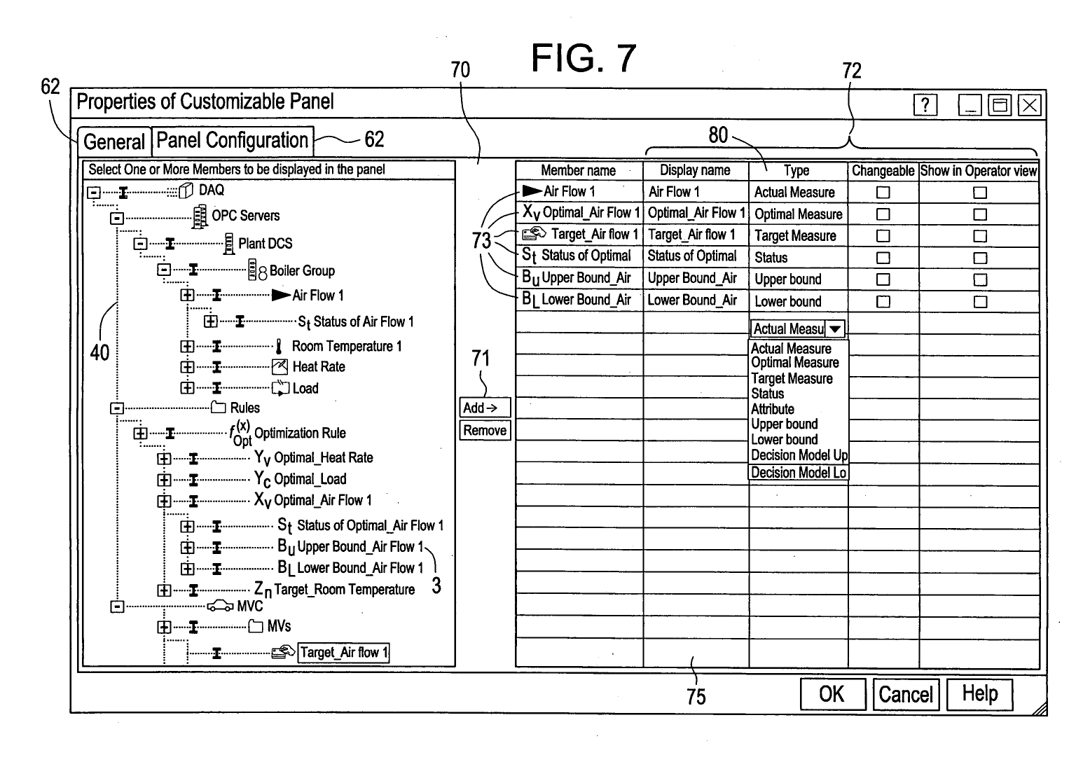

Some typical aspects of the panel configuration page 70 include, without limitation, the control tree 40 that shows the list of variables 3 and a tag listing 75. The tag listing 75 typically allows the user define how each tag 73 should behave and be visualized. The tag listing 75 includes various attributes 72 or properties related to each tag 73. For example, the “member name” field identifies the selected tag 73 (member in the block 26). In other examples depicted, “display name” reflects the name displayed for the respective tag 73. This helps the user configuring the CIP 52 to specify a desired name for the tag 73. “Type” defines how to display the data (discussed further herein and in relation to FIG. 7). “Changeable” status defines if the output 14 may be changed from within the display client 22, while “Show in Operator view” toggles the underlying operational data 1 visibility in the display system. In one embodiment, underlying operational data 1 is not visible to operators in an operator view.

Referring to FIGS. 7-9, there are shown aspects of techniques for changing attributes 72. In FIG. 7, a pick-list (or a “pull-down menu”) is provided, which includes a list of appropriate options for selecting a type 80 associated with the respective tag 73. As a non-limiting example, it may be appropriate to select one of “actual measure,” “optimal measure,” “target measure,” “status,” “attribute,” “upper bound,” “lower bound,” “decision model up,” and “decision model down” when entering or changing a type 80.

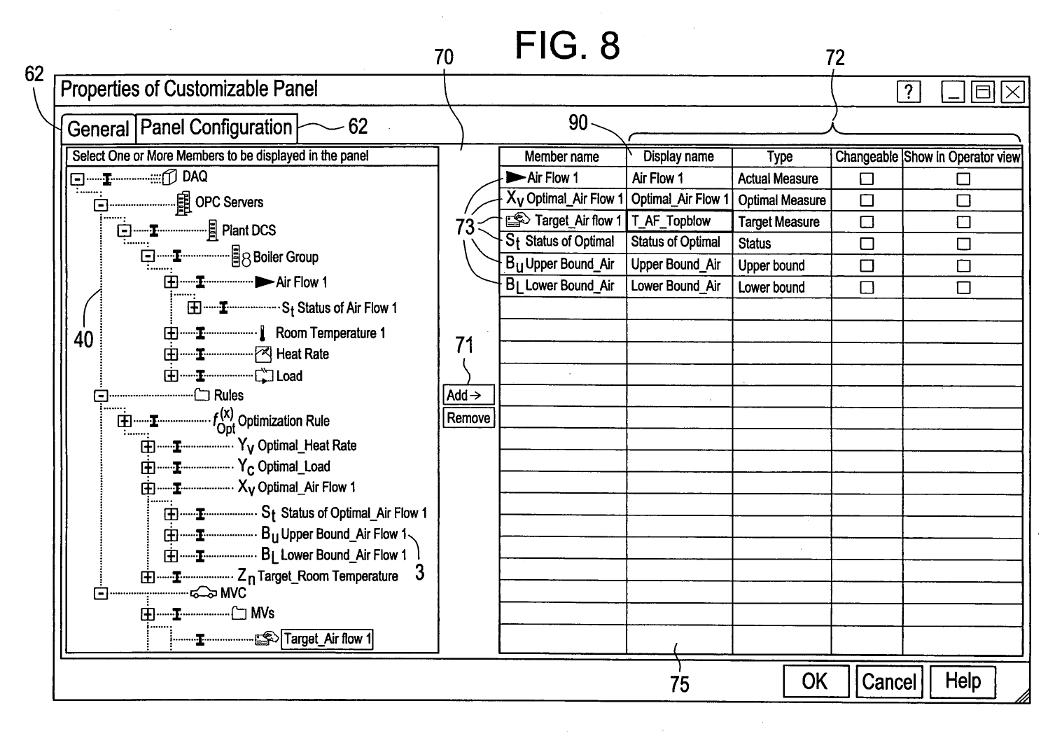

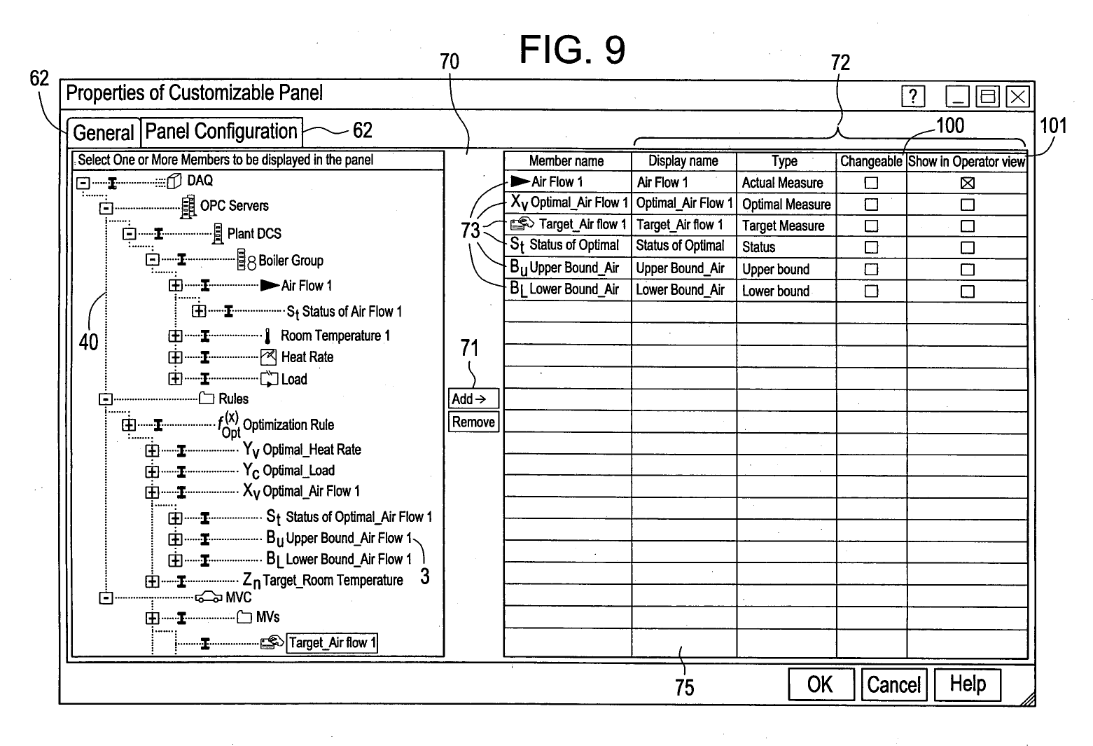

FIG. 8 depicts a technique for changing the display name 90, wherein naming data is keyed in by the user into a user-fillable field. This technique is useful for entering a unique display name 90 for the respective tag 73. Another technique for changing an attribute 72 is depicted in FIG. 9, wherein the user is provided a checkbox field to indicate changeable status 100 and Show in Operator view 101. Of course, these techniques may be complimented, combined as appropriate or supplanted by other techniques, such use of radio buttons, auto-association, etc, . . . .

Referring again to FIG. 7, various options in the pick-list provide users with various types 80 for presentation of output 14. For example, regarding “actual measurement,” the user should select this type 80 to flag the actual value or set-point for the respective tag 73. Regarding “optimal measurement,” the user should select this type 80 to flag an optimal value or set-point or to initiate optimization of the tag 73. Regarding “target measurement,” the user should select this type 80 to flag the tag 73 for multi-variable control. Regarding “status,” the user should select this type 80 to flag the status for viewing. Note that in some embodiments, the status of all variables 3 would be selectable form the control tree 40. Regarding “attribute,” the user should select this type 80 to flag the Attributes 72 for viewing. Regarding “Upper Bound,” the user should select this type 80 to flag the upper bound of the measurements for use during optimization of the variable 3. Regarding “Lower Bound,” the user should select this type to flag the lower bound of the measurements for during optimization of the variable 3. Regarding “Decision Model Upper Bound,” the user should select this type 80 to flag the soft upper bound of the measurements for use in a decision model, while “Decision Model Lower Bound” should be selected for use during optimization of the variable 3.

In some embodiments, display name 90 defaults to the value assigned as the member name. However, the display name 90 should be editable as shown in FIG. 8. Typically, the changeable status 100 and Show in Operator view 101 attributes 72 include checkboxes that can be checked and unchecked as desired.

In other embodiments, other attributes 72 are used in addition to or in place of the foregoing exemplary and non-limiting attributes 72.

In further embodiments, other information is included in the block 26. In a non-limiting example, each of a rule result, a predictor result, and an optimizer result might be included. In these examples, such other information might be useful for displaying aspects such as acceptability, trend information and desired status. Such other information might be derived from, for example, engineering principles, probability assessments, weighting factors, physical properties, system dynamics and prior system performance.

As described in the foregoing, blocks 26 and the information stored therein, are readable by the display client 22 to provide for display of output 14 related to processes of the industrial system 2.

II. The Display Client 22

The display client 22 is a tool for presenting output 14 to the user using various display systems. The display systems are used to provide various presentations of salient data. For example, in one embodiment, the software component 10 provides a display referred to as an “operator display,” and another display as an “analysis display.” Typically, the operator display provides relevant information to operators of the industrial system 2 in a manner that is as ergonomically useful as possible for system operators. In contrast, the analysis display frequently is set to provide system managers (of the software component 10) with in depth resources, such as may be needed to evaluate performance, manage, troubleshoot, etc, . . . . Accordingly, one can surmise that the software component may be tailored to meet the display needs of the user.

Data presented by the software component 10 may be regarded as a “summary” of information called for by a block 26. The summary may include, as non-limiting examples, current status, normalized status, trend information, upper bounds, lower bounds, average values, extreme values, and other types of information. In short, the term “summary” is non-limiting of the teachings herein. In typical embodiments, the summary provides a concise and meaningful representation of current conditions of the industrial system 2, where current is defined to have a rate of change that meets the needs of the operators of the industrial system 2.

Although the display client 22 is discussed herein in terms of a bar graph 1100, it should be understood that many forms are known for presentation of data. For example, trend plots, histograms, pie charts, line graphs, scatter graphs and other forms of data presentation may provide certain advantages when used in conjunction with the teachings herein. Accordingly, the bar graph 1100 is an exemplary and non-limiting embodiment of data presentation.

The operator display typically shows data in a scaled format between two bounds (lower and upper) using various styles as well as present additional information in listed format were applicable. The term “style” is used to indicate the drawing method of the scales and values on the bar graph. The term “layout” refers to the way items are positioned on the bar graph.

One of the most common uses for the bar graph 1100 is to view data for multi-variable control (MVC) points, rules and blocks 26.

While information related to each block 26 is governed in great regard by the configuration defined through the block object 21, some aspects of the information are governed by the display client 22. For example, bar graph types will dictate the layout of the information graphically.

In some embodiments, a default layout is assigned when viewing aspects such as MVC, and Optimization and Predictor Rules. Users seeking to customize the bar graph layout and modify associated values can setup or edit a block 26 as described above.

Typically, bar graphs 1100 are displayed in a bar graph view pane of the operator display. Frequently, the display client 22 is configured to provide users with an ability to customize the style of each bar graph 1100. In some embodiments, the display client 22 provides right click menus for interaction by an operator, as well as features for an operator to modify additional attributes for a block 26 underlying a specific bar graph 1100 (if the attributes 72 were previously designated as changeable). Perhaps most importantly, the display client 22 provides for visual and other indications when a predicted value is outside the multi-variable control (MVC) constraints.

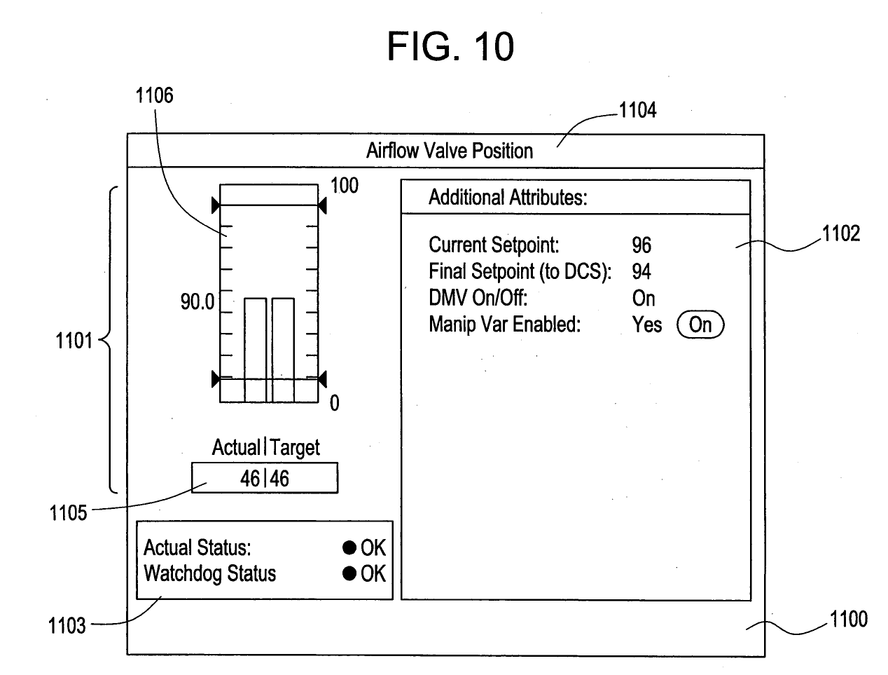

Referring to FIG. 10, an exemplary bar graph 1100 is shown. In this illustration, the bar graph 1100 includes a bar graph drawing area 1101. In some embodiments, this includes a numeric display 1105 in addition to a graphic display 1106 of values associated with the block 26. An attribute information area 1102 is also depicted. The attribute information area 1102 is typically used to display additional set-point information or associated data in a list format. A status information area 1103 is also depicted and provides status information in a list format. Typically, a bar graph title 1104 is included to provide a clear indication of the block 26 to which the bar graph 1100 is associated.

Regarding the style of each bar graph 1100, it is typical that facilities are provided for users to customize the style in which to graphically draw the bar graph 1100 using a mixture of vertical bars and arrows. Typically, the style for each bar graph 1100 is customized through use of a Style Setup Dialog as a part of the context menu 29. Exemplary styles of bar graphs 1100 are provided below.

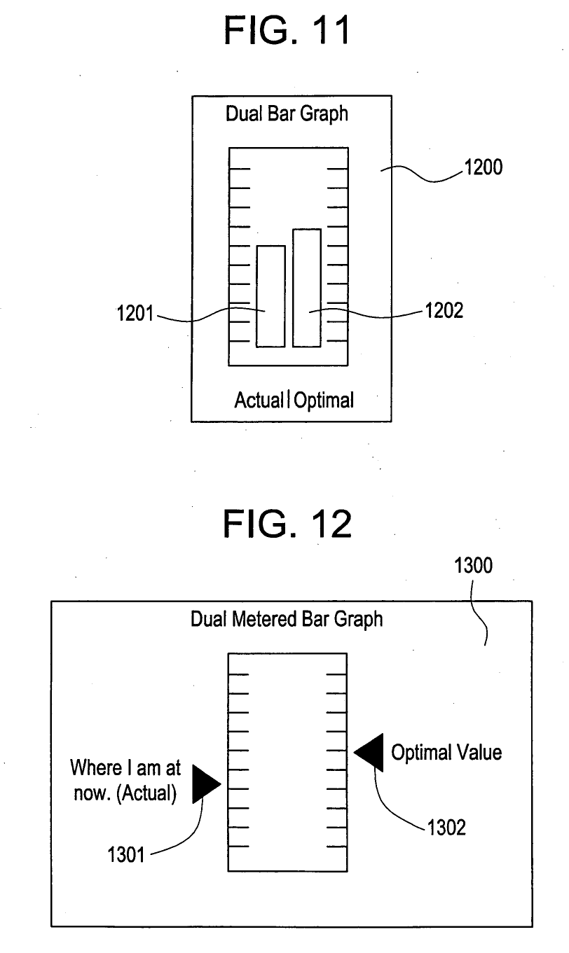

A first style of bar graph 1100 is the split vertical bar graph 1200, depicted in FIG. 11. In FIG. 11, the actual value for the block 26 is to the left and the optimal value is to the right. In a number of embodiments, the user will be able to have up to three vertical bars display on a single bar graph 1100. These bars include an actual value bar 1201, an optimal value 1202 and the difference (a calculated value based on the actual and optimal values-not shown).

Another exemplary style attribute for each bar graph 1100 includes the addition of sidebar arrow indicators 1300, depicted in FIG. 12. In FIG. 12, an actual value arrow 1301 appears on the left-hand side, an optimal value arrow 1302 appears on the right hand side.

In general, the bar graph 1100 is created and customized using a context menu 29. Non-limiting examples of features that are selectable in the context menu 29 for all variables 3, including blocks 26, include: display the title of the points and rules as well as the variables 3 and tags 73 being viewed; the minimum and the maximum viewable scale range; whether the bar graph 1100 is visually scalable and includes zoom support; as well as default values, styles and layout for aspects such as MVC, OPC, API points, optimization (estimation) and predictor rules, values displayable in numerical text form, minimum and maximum scale values as well as the various instances of text that may appear in the bar graph 1100.

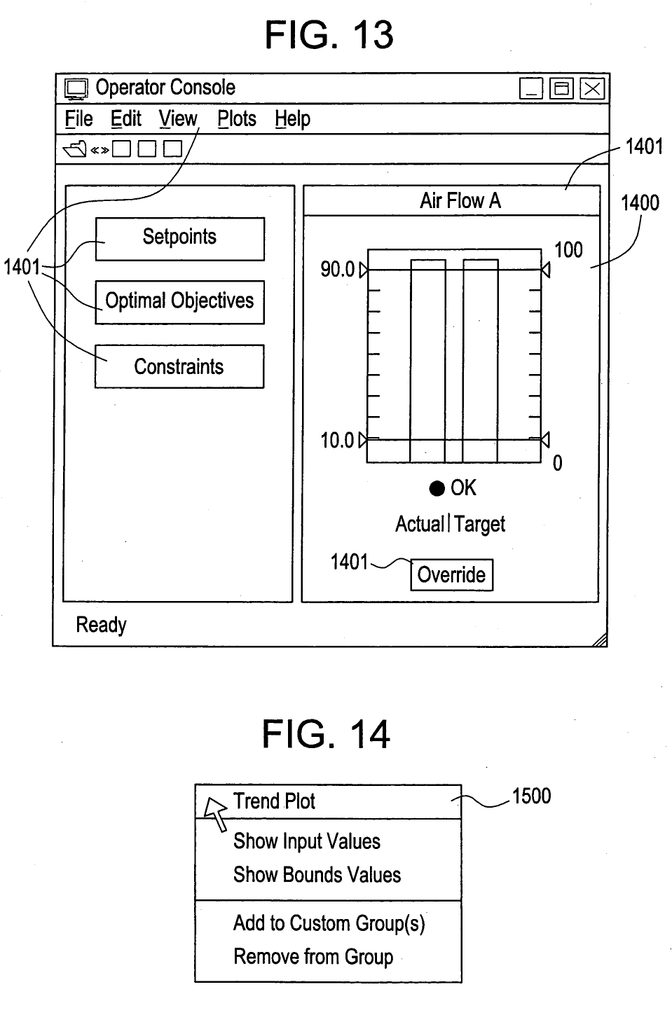

An exemplary context menu 29 is depicted in FIG. 13. Referring to FIG. 13, there are shown context customizing features 1401 for tailoring the context of a given bar graph 1100. Such customizing features may include, in non-limiting embodiments, radio-buttons, check boxes, selectable ranges, auto-fill fields, pick lists, user fillable fields, and others.

Typically, convenient techniques are used for initiating interaction with the software component 10. For example, right-click menu interaction may be used within the display client to provide users with ability to launch plots (trend, performance, pareto, etc); an ability to hide or show input values in text form; and an ability to hide or show bound values in text form.

In the analysis view, right clicking will frequently enable users to add or remove components such as bar graphs 1100. In some embodiments in the operator view, right clicking will enable users to add or remove bar graphs from groups. An exemplary customizing menu 1500 invoked by right clicking is depicted in FIG. 14. In typical embodiments, the customizing menu 1500 appears at the current location of the screen pointer when the user performs the right click.

In typical embodiments, the display client 22 provides support for block-specific behavior. In a non-limiting example, the display client 22 includes support for displaying blocks 26 based on type 80, wherein the types “actual,” “optimal” and “immediate target value” are displayed in the bar graph drawing area 1101; the types 80 “upper bound” and “lower bound” are displayed in the bar graph drawing area 1101 and additional attribute information area 1102; the type 80 “status” is displayed in the status information area 1103; the type “property” is displayed in the additional attribute information area 1102; the type 80 “button” is displayed in the additional attributes information area 1102 (typically next to manually controllable variables and appears graphically as a light-bulb to denote “on” and “off”).

In some embodiments, right-click menu interaction for blocks 26 provides users with an ability to select which actual value is shown in the bar graph 1100 (if multiple actual values have been configured for a single block 26) from the tags 73. In additional embodiments, right-click menu interaction for blocks 26 provides users with an ability to filter which bounds to view in the bar graph 1100 from the tag listing 75.

In some embodiments, support for modifying properties in a block 26 through the additional attributes information area 1102 is included.

Some embodiments includes support to permit users to modify lower and upper soft-bounds in the block 26 by moving the bounds via a mouse drag in the bar graph drawing area 1101.

In other embodiments, the minimum and the maximum viewable scale range is configurable. Typically, default is to the first variable added to the block 26 and its respective bounds.

In some embodiments where the bar graph 1100 has changeable variables 3 in the additional attributes information area 1102, an override button (not shown) is available to provide for manual control. In some embodiments, the override button will permit users to set manual control and input into the software component 10.

In some embodiments, the display client 22 provides for robust performance. Aspects of performance are provided in Table 1.

TABLE 1
Display Client Performance

| Specification | Description | Testable Range |
|---|---|---|
| Graphical | Number of allowable | Up to three: |
| Variables | variables to be | 1. Actual |
| displayed. | graphically drawn. | 2. Optimal |
| | | 3. Difference or Target |
| | | vertical value. |
| Attribute | Number of attribute | Up to 30. |
| Variables | variables displayable. | |
| Displayed. | | |
| Status Variables | Number of status | Up to 10. |
| Displayed. | variables displayable. | |
| Instances of Bar | The number of Bar | Up to 100. |
| Graphs. | Graphs that can be | |
| | displayed at one time. | |

In further embodiments, the display client 22 permits users to view at least one hundred bar graphs 1100 simultaneously. Although in typical use it is only possible to view one “actual value” member for each block 26 on the respective bar graph 1100, it is possible to view up to eight “bounds” members for a block 26 on one bar graph 1100.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for providing a summary for at least one process of a system, the apparatus comprising:
a block object for accepting input data descriptive of the at least one process and for grouping as a block at least one variable of the input data with at least one attribute for the variable; and a display client for reading the block and producing output to display the summary for the at least one process.

2. The apparatus as in claim 1, wherein the input data comprises at least one of historic data, predictive data, improved data, calculated data, derived data, reference data, real-time data, approximately real-time data, data collected by system sensors, operational data, manual input data and projected data.

3. The apparatus as in claim 1, wherein the at least one attribute comprises at least one of a member name, a display name, a type, a display changeable status and a visibility option.

4. The apparatus as in claim 3, wherein the type comprises a type for indicating one of an actual value, a set-point, an estimated value, an upper bounds and a lower bounds.

5. The apparatus as in claim 3, wherein the type comprises a type for initiating one of an optimization estimation, a flagging for multi-variable control, and a flagging for viewing.

6. The apparatus as in claim 1, wherein the block further comprises information of at least one of a rule result, a predictor result, and an estimation result.

7. The apparatus as in claim 6, wherein the information comprises information descriptive of at least one of engineering principles, probability assessments, weighting factors, physical properties, system dynamics and prior system performance.

8. The apparatus as in claim 1, wherein the system comprises one of an industrial system, a power plant and a medical setting.

9. The apparatus as in claim 1, wherein the block object comprises a user interface for selecting the at least one variable and the at least one attribute.

10. The apparatus as in claim 9, wherein the user interface comprises at least one of a graphical user interface (GUI), a control tree structure and a tag listing.

11. The apparatus as in claim 1, wherein the display client comprises a context menu for customizing the appearance of the output.

12. The apparatus as in claim 1, comprising at least one of a computer system, a network, at least one sensor, a server, a display system and a remote access.

13. The apparatus as in claim 1, wherein the apparatus is an enhancement to an existing system.

14. A method for providing a summary for at least one process of a system, the method comprising:
selecting a block comprising at least one variable descriptive of the process with at least one attribute for the variable;
using a display client, reading the block to produce output; and,
displaying the output as the summary for the at least one process.

15. The method as in claim 14, further comprising creating the block by using a block object to select the at least one variable and the at least one attribute.

16. The method as in claim 14, wherein providing comprises at least one of a continuous basis, about a real-time basis, a periodic basis and a frequent basis.

17. The method as in claim 14, wherein displaying comprises using at least one of a bar graph, a trend plot, a histogram, a pie chart, a line graph, a scatter graph, a performance plot and a pareto plot.

18. The method as in claim 17, wherein the bar graph comprises at least one of a bar graph drawing area, a numeric display, an attribute information area, a status information area, a bar graph title, and at least one sidebar arrow indicator.

19. The method as in claim 18, wherein the displaying further comprises accepting a user input for modifying properties of the display.

20. An apparatus for providing a summary for at least one process of a system, the apparatus comprising:
means for accepting input data descriptive of the at least one process and for grouping as a block at least one variable of the input data with at least one attribute for the variable; and display means for reading the block and producing output to display the summary for the at least one process.
